(19) United States
(12) Patent Application Publication
(10) Pub. No.: US 2026/0141921 A1
(43) Pub. Date: May 21, 2026

(54) SYSTEM AND METHOD FOR IMPLEMENTING A MULTI-PERSPECTIVE MEMORY GENERATOR

(71) Applicant: Interactive Memories, Inc. d/b/a Mixbook, Redwood, CA (US)

(72) Inventors: Robin R. Johnson, Newton, MA (US); David J. Charles, Arlington, MA (US); Daniel Andrew Laffoon, Mountain View, CA (US); Vladislav Lebedev, Chisinau (MD); Petre Negrei, Chisinau (MD); David P. Newhoff, San Rafael, CA (US)

(21) Appl. No.: 19/389,263

(22) Filed: Nov. 14, 2025

Related U.S. Application Data
(60) Provisional application No. 63/720,840, filed on Nov. 15, 2024.

(51) Int. Cl. G11B 27/031

(52) U.S. Cl. CPC G11B 27/031

(57) ABSTRACT

The present disclosure relates to a method for generating a multi-perspective memory. Embodiments may include receiving a plurality of media elements and contextual information from one or more author-users, extracting the received plurality of media elements and contextual information into a machine-readable format, where the API may be configured to employ a retrieval-augmented generation (RAG) natural language processing technique, and organizing the extracted plurality of media elements into one or more memory structures. Embodiments may also include sequencing the one or more memory structures into an underlying plurality of ordered events, and enhancing the plurality of ordered events to form one or more narrative sequences.

### CROSS-REFERENCE TO RELATED APPLICATIONS

This application claims the benefit of U.S. provisional application 63/720,840, which was filed on Nov. 15, 2024, the contents of which are hereby incorporated by reference in its entirety.

### FIELD OF INVENTION

The present invention is in the field of electronic commerce and pertains particularly to a method and apparatus for the automated creation and editing of media-based projects using a graphical user interface over a communications network.

### BACKGROUND

In the field of electronic commerce, also known as e-commerce, there may be interactive websites that assist users in creating photo-based projects such as photo-books, photo-calendars, photo-cards, and photo-invitations. Such interactive websites may allow users to upload photos, videos, comments, and other context that can be used to interact with the websites in order to create photo-based projects customized to a user's preferences.

Technology services that enable the generation of physical photo books may be derived from digital image content and metadata, as well as user-generated content. Such services may traditionally exist in printed and bound physical formats, and may also exist digitally as a binary file used for the printed output. Many different websites may provide and support physically printed photo books while relying on binary, like-for-like printed output file(s).

### SUMMARY

In one or more embodiments of the present disclosure, a method for generating a multi-perspective memory is provided. The method may include receiving, via at least one processor, a plurality of media elements and contextual information from one or more author-users, extracting, via an application programming interface (API), the received plurality of media elements and contextual information into a machine-readable format, where the API may be configured to employ a retrieval-augmented generation (RAG) natural language processing technique, and organizing, via the API, the extracted plurality of media elements into one or more memory structures. The method may also include sequencing, via the API, the one or more memory structures into an underlying plurality of ordered events, and enhancing, via the API, the plurality of ordered events to form one or more narrative sequences.

One or more of the following features may be included. The method may further include compiling, using a multi-modal video compiler, the one or more enhanced narrative sequences into an audio-visual depiction of a first memory, providing the audio-visual depiction to one or more users via a media consumption broker, and updating the one or more memory structures based on user interactions with the audio-visual depiction to generate a first evolving memory representation. The associations between each media element, the system-validated truths, and the subject identifiers are based on neural network routines within an artificial intelligence (AI) foundation model. Organizing the extracted plurality of media elements may include generating a multidimensional array configured to relate each media element to one or more contextual descriptors and subject relationships. The received contextual information may include at least one of: captions, page placement, media emphasis, time metadata, subject identity, or user-supplied annotations. The method may further include generating one or more alternate video depictions using a multi-creator perspective multiplexer, where each alternate video depiction may correspond to a different user viewpoint. Enhancing the ordered events may include at least one of: assigning soundtrack selections, narration, or visual styles based on inferred emotional context of the memory. Updating the one or more memory structures may include non-destructively incorporating user edits, commentary, or personalization as additional context. The method may further include maintaining separate role-based permissions for users, where each user may be designated as at least one of: an author, a contributor, or a consumer, and generating subject-specific timelines by associating memory structures with corresponding identified subjects. Compiling the one or more enhanced narrative sequences may include applying saliency detection to emphasize relevant regions of the media elements. Updating the memory structures may further include retraining a foundation model using reinforcement learning derived from user interactions. The method may further include generating one or more child memory depictions as sub-structures of the compiled audio-visual memory depiction, where each child memory depiction may represent a moment within the audio-visual depiction of the first memory, and enabling cross-user augmentation of one or more memory structures, such that additional contextual information supplied by a first user associated with the first evolving memory representation is integrated into a second evolving memory representation associated with a second user, where both the first and second users are identified as participating in at least one common event from the underlying plurality of ordered events included in the first evolving memory representation.

In one or more embodiments of the present disclosure, a non-transitory computer-readable storage medium having stored thereon instructions, which, when executed by a processor, result in one or more operations, is provided. The operations may include receiving, via at least one processor, a plurality of media elements and contextual information from one or more author-users, extracting, via an application programming interface (API), the received plurality of media elements and contextual information into a machine-readable format, where the API may be configured to employ a retrieval-augmented generation (RAG) natural language processing technique, and organizing, via the API, the extracted plurality of media elements into one or more memory structures. The operations may also include sequencing, via the API, the one or more memory structures into an underlying plurality of ordered events, and enhancing, via the API, the plurality of ordered events to form one or more narrative sequences.

One or more of the following features may be included. The operations may further include compiling, using a multi-modal video compiler, the one or more enhanced narrative sequences into an audio-visual depiction of a first memory, providing the audio-visual depiction to one or more users via a media consumption broker, and updating the one or more memory structures based on user interactions with the audio-visual depiction to generate a first evolving memory representation. The associations between each media element, the system-validated truths, and the subject identifiers are based on neural network routines within an artificial intelligence (AI) foundation model.

In one or more embodiments of the present disclosure, a system for generating a multi-perspective memory is provided. The system may include at least one processor configured to execute one or more operations. The operations may include receiving, via at least one processor, a plurality of media elements and contextual information from one or more author-users, extracting, via an application programming interface (API), the received plurality of media elements and contextual information into a machine-readable format, where the API may be configured to employ a retrieval-augmented generation (RAG) natural language processing technique, and organizing, via the API, the extracted plurality of media elements into one or more memory structures. The operations may also include sequencing, via the API, the one or more memory structures into an underlying plurality of ordered events, and enhancing, via the API, the plurality of ordered events to form one or more narrative sequences.

One or more of the following features may be included. The operations may further include compiling, using a multi-modal video compiler, the one or more enhanced narrative sequences into an audio-visual depiction of a first memory, providing the audio-visual depiction to one or more users via a media consumption broker, and updating the one or more memory structures based on user interactions with the audio-visual depiction to generate a first evolving memory representation. Organizing the extracted plurality of media elements may include generating a multidimensional array configured to relate each media element to one or more contextual descriptors and subject relationships.

### BRIEF DESCRIPTION OF THE DRAWINGS

The accompanying drawings, which are included to provide a further understanding of embodiments of the present disclosure and are incorporated in and constitute a part of this specification, illustrate embodiments of the present disclosure and together with the description serve to explain the principles of embodiments of the present disclosure.

FIG. 1 diagrammatically depicts a computing network that facilitates a photo book creation;

FIG. 2 shows a flowchart depicting operations consistent with an embodiment of the physical photo book printing and delivery;

FIG. 3 diagrammatically depicts a memory generation process coupled to a distributed computing network;

FIG. 4 depicts a block diagram of a photo book creation process, according to embodiments of the present disclosure;

FIG. 5 depicts a block diagram of the relationship between a memory and automatically created sequenced depictions of that memory, and the personalized versions of those depictions, according to embodiments of the present disclosure;

FIG. 6 depicts a block diagram of how a memory is created and improved by users of different role types, according to embodiments of the present disclosure; and

FIG. 7 shows an exemplary flowchart of a memory generation process, in accordance with embodiments of the present disclosure.

### DETAILED DESCRIPTION

Reference will now be made in detail to the embodiments of the present disclosure, examples of which are illustrated in the accompanying drawings. The present disclosure may, however, be embodied in many different forms and should not be construed as being limited to the embodiments set forth herein; rather, these embodiments are provided so that this disclosure will be thorough and complete, and will fully convey the concept of the present disclosure to those skilled in the art. Like reference numerals in the drawings denote like elements.

Please note, the disclosure of U.S. Pat. No. 8,923,551, entitled “Systems and methods for automatically creating a photo-based project based on photo analysis and image metadata”, is hereby incorporated by reference in its entirety for all purposes.

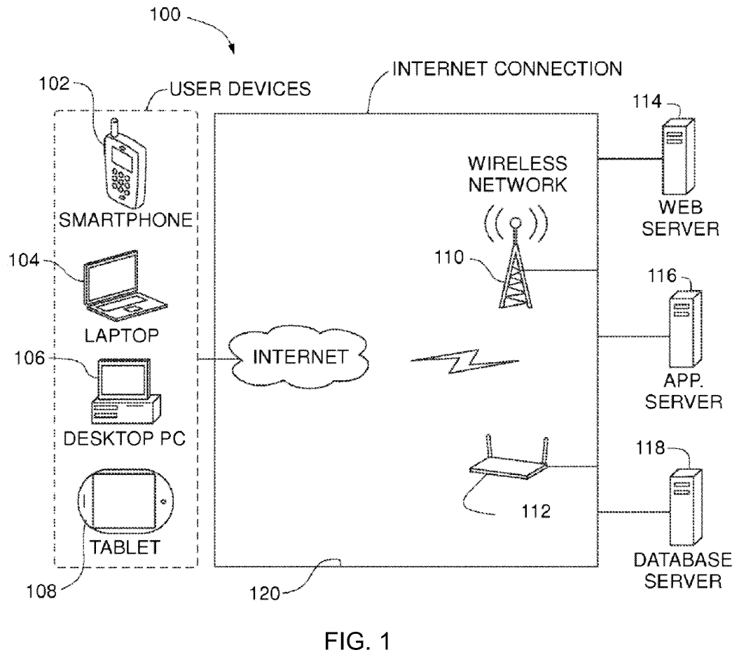

Referring to FIG. 1, a schematic diagram of a network configuration 100 for practicing embodiments of the present invention is shown (this embodiment may sometimes be referred to as “MONTAGE”). A user device or devices may be connected to the Internet using a wireless network or a wired network. A user-device may be a smartphone 102, laptop 104, desktop PC 106, or tablet 108. The wireless network may comprise a cellular tower 110 or a wireless router 112. User devices may be connected to servers comprising a web server 114, an application server 116, and a database server 118. The servers may be connected to a user device through the wireless network, or the wired network 120. The wired network 120 or the wireless network may employ technologies and protocols comprising Ethernet technology, Local Area Network (LAN), Wide Area Network (WAN), optical network, and the like.

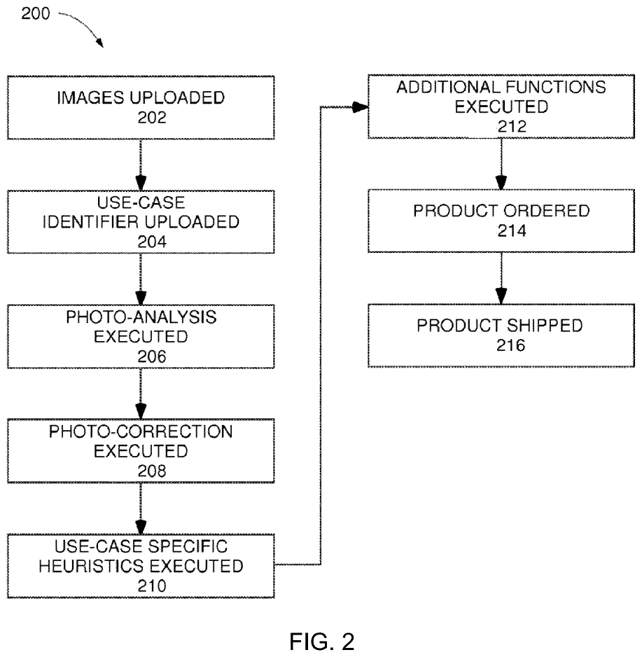

Referring now to FIG. 2, a flow chart (e.g., flow chart 200), according to embodiments of the present disclosure, is provided. Flow chart 200 may describe the process of facilitating the creation of photo-based projects over a communications network. Among other things, flow chart 200 may depict the flow of data and the flow of control employed to facilitate the creation of photo-based projects over a communications network, according to one embodiment. Flow chart 200 of the disclosed embodiments may begin with step 202, wherein the user provides, via his or her device over the network, at least a plurality of images or photos to the server for storage in the database. In one embodiment, the images or photos may be provided to a server via a graphical user interface executing on the device. In another embodiment, the images or photos may be provided to the server for storage in the database via TCP/IP and/or HTTP over the network. Subsequently, the server may store the images or photos in the database as records. In one embodiment, the records are stored in association with an identity for a user or in association with a user record for the user.

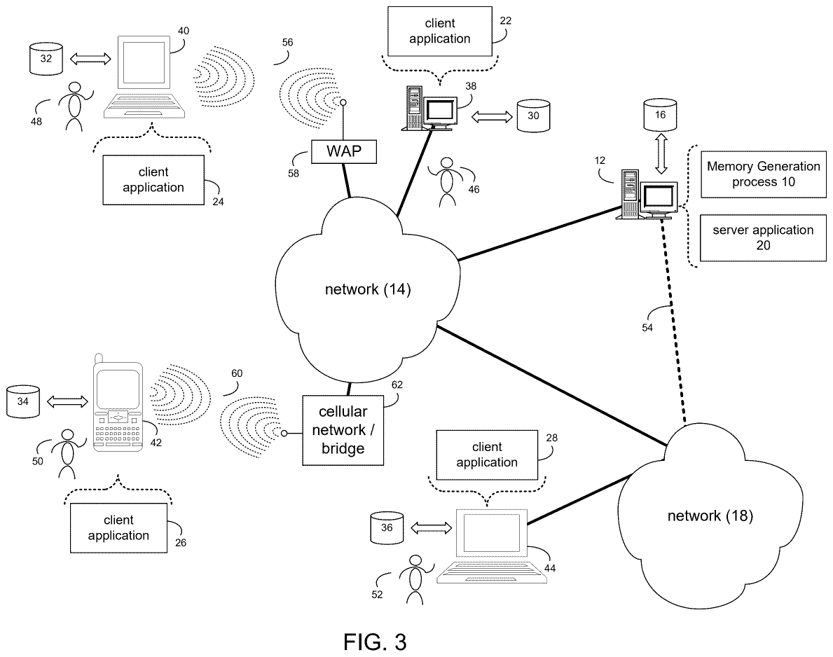

Referring to FIG. 3, there is shown memory generation process 10 that may reside on and may be executed by server computer 12, which may be connected to network 14 (e.g., the internet or a local area network). Examples of server computers 12 may include, but are not limited to, a personal computer, a server computer, a series of server computers, a mini-computer, and a mainframe computer. Server computer 12 may be a web server (or a series of servers) running a network operating system, examples of which may include but are not limited to: Microsoft Windows XP Server™; Novell Netware™; or Redhat Linux™, for example. Additionally, and/or alternatively, the routing topology process may reside on a client electronic device, such as a personal computer, notebook computer, personal digital assistant, or similar device.

The instruction sets and subroutines of the memory generation process 10, which may be stored on storage device 16 coupled to server computer 12, may be executed by one or more processors (not shown) and one or more memory architectures (not shown) incorporated into server computer 12. Storage device 16 may include but is not limited to: a hard disk drive; a tape drive; an optical drive; a RAID array; a random access memory (RAM); and a read-only memory (ROM).

Server computer 12 may execute a web server application, examples of which may include but are not limited to: Microsoft IIS™, Novell Webserver™, or Apache Webserver™, that allows for HTTP (i.e., HyperText Transfer Protocol) access to server computer 12 via network 14. Network 14 may be connected to one or more secondary networks (e.g., network 18), examples of which may include but are not limited to: a local area network; a wide area network; or an intranet, for example.

Server computer 12 may execute one or more server applications (e.g., server application 20), examples of which may include but are not limited to, e.g., Microsoft Exchange™ Server, etc. Server application 20 may interact with one or more client applications (e.g., client applications 22, 24, 26, 28) in order to execute memory generation process 10. Examples of client applications 22, 24, 26, 28 may include, but are not limited to, EDAs or design verification tools such as those available from the assignee of the present disclosure. These applications may also be executed by server computer 12. In some embodiments, memory generation process 10 may be a stand-alone application that interfaces with server application 20 or may be applets/applications that may be executed within server application 20.

The instruction sets and subroutines of server application 20, which may be stored on storage device 16 coupled to server computer 12, may be executed by one or more processors (not shown) and one or more memory architectures (not shown) incorporated into server computer 12.

As mentioned above, in addition, or as an alternative to being server-based applications residing on server computer 12, Memory generation process 10 may be a client-side application residing on one or more client electronic devices 38, 40, 42, 44 (e.g., stored on storage devices 30, 32, 34, 36, respectively). As such, memory generation process 10 may be a stand-alone application that interfaces with a client application (e.g., client applications 22, 24, 26, 28), or may be applets/applications that may be executed within a client application As such, Memory generation process 10 may be a client-side process, server-side process, or hybrid client-side/server-side process, which may be executed, in whole or in part, by server computer 12, or one or more of client electronic devices 38, 40, 42, 44.

The instruction sets and subroutines of client applications 22, 24, 26, 28, which may be stored on storage devices 30, 32, 34, 36 (respectively) coupled to client electronic devices 38, 40, 42, 44 (respectively), may be executed by one or more processors (not shown) and one or more memory architectures (not shown) incorporated into client electronic devices 38, 40, 42, 44 (respectively). Storage devices 30, 32, 34, 36 may include, but are not limited to: hard disk drives; tape drives; optical drives; RAID arrays; random access memories (RAM); read-only memories (ROM), compact flash (CF) storage devices, secure digital (SD) storage devices, and memory stick storage devices. Examples of client electronic devices 38, 40, 42, 44 may include, but are not limited to, a personal computer 38, a laptop computer 40, a personal digital assistant 42, a notebook computer 44, a data-enabled, cellular telephone (not shown), and a dedicated network device (not shown), for example. Using client applications 22, 24, 26, 28, users 46, 48, 50, 52 may utilize the EDA to create an electronic design.

Users 46, 48, 50, 52 may access server application 20 directly through the device on which the client application (e.g., client applications 22, 24, 26, 28) is executed, namely client electronic devices 38, 40, 42, 44, for example. Users 46, 48, 50, 52 may access server application 20 directly through network 14 or through secondary network 18. Further, server computer 12 (e.g., the computer that executes server application 20) may be connected to network 14 through secondary network 18, as illustrated with phantom link line 54.

In some embodiments, memory generation process 10 may be a cloud-based process, as any or all of the operations described herein may occur, in whole or in part, in the cloud or as part of a cloud-based system. The various client electronic devices may be directly or indirectly coupled to network 14 (or network 18). For example, personal computer 38 is shown directly coupled to network 14 via a hardwired network connection. Furthermore, notebook computer 44 is shown to be directly coupled to network 18 via a hardwired network connection. Laptop computer 40 is shown wirelessly coupled to network 14 via wireless communication channel 56 established between laptop computer 40 and wireless access point (i.e., WAP) 58, which is shown directly coupled to network 14. WAP 58 may be, for example, an IEEE 802.11a, 802.11b, 802.11g, Wi-Fi, and/or Bluetooth device that is capable of establishing wireless communication channel 56 between laptop computer 40 and WAP 58. Personal digital assistant 42 is shown wirelessly coupled to network 14 via wireless communication channel 60 established between personal digital assistant 42 and cellular network/bridge 62, which is shown directly coupled to network 14.

As is known in the art, all of the IEEE 802.11x specifications may use Ethernet protocol and carrier sense multiple access with collision avoidance (CSMA/CA) for path sharing. The various 802.11x specifications may use phase-shift keying (PSK) modulation or complementary code keying (CCK) modulation, for example. As is known in the art, Bluetooth is a telecommunications industry specification that allows e.g., mobile phones, computers, and personal digital assistants to be interconnected using a short-range wireless connection.

Client electronic devices 38, 40, 42, 44 may each execute an operating system, examples of which may include but are not limited to Microsoft Windows™, Microsoft Windows CE™, Redhat Linux™, Apple iOS, ANDROID, or a custom operating system.

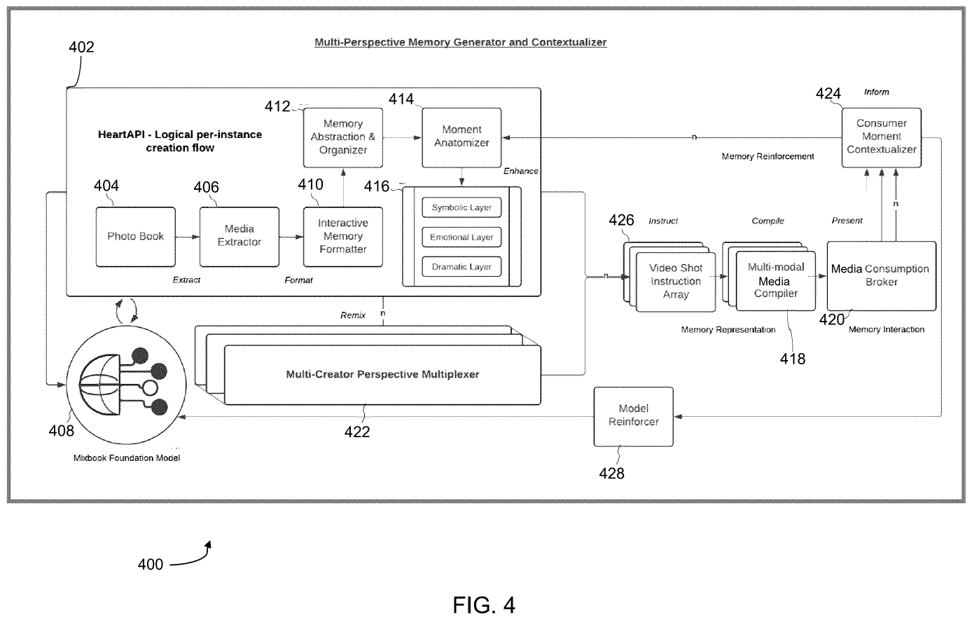

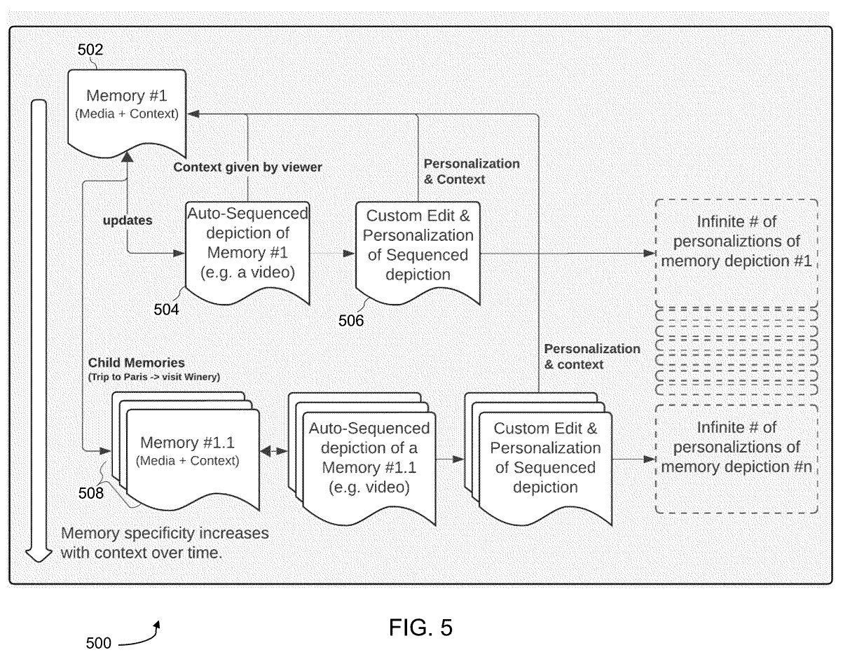

Referring now to FIGS. 4-5, a block diagram (e.g., block diagram 400) illustrating the photo book creation process, and a block diagram (e.g., block diagram 500) of a relationship between a memory (e.g., memory 502) and automatically created sequenced depictions (e.g., auto-sequenced depictions 504) of memory 502, and the personalized versions of those depictions (e.g., personally-sequenced depictions 506), according to embodiments of the present disclosure, are provided. At the heart of memory generation process 10, an application programming interface (e.g., heart API 402) that encapsulates media extraction, memory organization, and enhancement necessary to inform media sequencing instructions based on multi-subject perspectives. In its primitive form, heart API 402 may carry out the core essentials of retrieval and pre-processing to employ search algorithms to query external data and media element (computer vision) insights, as well as grounded generation of new information, which may in turn be re-incorporated into the artificial intelligence (AI) foundation model. The core functions of heart API 402 may employ a natural language processing technique commonly referred to as retrieval-augmented generation (RAG). The actions of heart API 402 may be influenced by the AI foundation model to produce stories while calibrating truths, and while also factoring in feedback in the form of consumer context gathered through consumer interactions with the memory, as depicted in the media sequence. Here, a memory may be considered a data construct, whereas a media sequence may be regarded as the product of the memory and the consumer interaction.

In some embodiments, RAG may be a process that leverages semantic search. i.e., comparing a word embedded for a question or insight against the words embedded in the documents. Instead of searching by static keywords to find relevant content based on a matching, the meaning and the context may be used to match against the existing documents, typically stored in a “vector database,” all of which may be processed outside of the LLM or core model. Augmentation may refer to the process where the retrieved data may be injected into the prompt at runtime. Generation may refer to the response being delivered to the target system or AI agent with the additionally tuned information factors applied to the response content.

In some embodiments, RAG may not be employed at all, in actuality the foundation model may benefit from any modern processes that may be employed to change the output of information from the model, by influencing the results before delivering onto the next downstream process.

In some embodiments, heart API 402 may also include a photo book (e.g., photo book 404), which may be a technologically-assisted digitally composed book of photos, made possible by technology services. In this embodiment, photo book 404 may be composed of digital image content and metadata as well as user-generated content. Photo book 404 in this context may exist purely in workable digital form (within a studio creation console). In general, photo books like photo book 404 may be commonly converted digitally as a binary file used for the printed output to facilitate printing and binding in physical form. For the purposes of this disclosure, photo book 404 may be a container for media and “context” together, where context may refer to details about the media, such as comments and featured photos.

In some embodiments, heart API 402 may further include a media extractor (e.g., media extractor 406), which may act as an indexer and extractor of the output of photo book 404 as guided by instructions provided by an AI foundation model's (e.g. AI foundation model 408) final result of the data processing performed by a neural network routine for a given instance, as applied to the relevant media and information elements from photo book 404, or from a series of “photos”, also referred to as “albums.”

In some embodiments, heart API 402 may also include an interactive memory formatter (e.g., interactive memory formatter 410) where media elements may be associated with factual system-believed truths based on the neural network routines within AI foundation model 408 and may be arranged into logical multidimensional arrays of information. The information may be multidimensional due to the many-to-many relationship between media elements in AI foundation model 408 and the result of multi-person/subject associations to these relational information structures.

In some embodiments, heart API 402 may also include a memory abstraction and organizer (e.g., memory organizer 412), where the multidimensional arrays of media elements that map onto factual system-believed truths may be further organized into events containing time-based tags that may be put into perspective with descriptors that adjust the tense based on the present date and time. This organizational tagging process may be essential to suggesting a sequence of events that closely matches the events and perspectives of the corresponding former real-world occurrences.

In some embodiments, heart API 402 may also include a moment anatomizer (e.g., moment anatomizer 414), where the element sequences from memory organizer 412 may be enhanced by moment anatomizer 414 by organizing the sequence of moments according to the understanding of AI foundation model 408 of the guiding factors necessary to convey an engaging story.

In some embodiments, heart API 402 may also include a layered moment enhancer (e.g., layered enhancer 416), which may be the output of moment anatomizer 414 and may be configured to perform structured object notation that aligns video moments with multipart assignments to the symbolic, emotional, and dramatic layers as a result of moment anatomizer 414.

In some embodiments, block diagram 400 may also include a multi-modal video compiler (e.g., video compiler 418) configured to use multipart tag instructions to parse out the resulting digital video clips and saliency regions within clips to form a continuous video composition that may ultimately be viewable by a human receiver, interacting with a media consumption broker (e.g., broker 420).

In some embodiments, block diagram 400 may also include a multi-creator perspective multiplexer (e.g., multiplexer 422), configured to convert curation of viewpoints into shot instructions that may be reordered based on consumer context. Here, “shot instructions” may refer to the articulation of how media may be reorganized in an art form over time (e.g., a movie) and/or space (e.g., an image, or interactive experience) with the goal of maximizing emotional impact based on the aforementioned “understanding” provided by the atomization processes. Note, consumer context may include things like captions, page placement, media emphasis, time metadata, subject identity, or user-supplied annotations. Multiplexer 422, may also be configured to retain one or more shot instruction histories and indices, and to emit a combined master shot instruction that may be relevant to all parties that may be considered to be engaged with the memory through a consumer moment contextualizer (e.g., contextualizer 424) as well as multipart video shot instructions that may exist as alternate “takes,” where each take may be recalled by all parties to view customized videos based on differing viewpoints and perspectives of the memory.

In some embodiments, block diagram 400 may also include a video shot instruction array (e.g., video shot instruction array 426) configured to receive output from moment anatomizer 414 and to relay multi-creator perspectives from multiplexer 422 as an array of serialized instructions which may be interpreted and factored into the compiled series of sequenced and multi-dimensionally ordered media elements that may ultimately be parsed, processed, and applied within video compiler 418. Additionally, in some embodiments, video compiler 418 may be a system comprised of media information pointers and multiple media formatting sequencing instructions, which may be received from upstream systems and events.

In some embodiments, block diagram 400 may also include a media consumption broker (e.g., broker 420) configured to act as a uniform resource identifier (URI) endpoint that may facilitate human user interaction with the sequenced media compilations. Broker 420 may both produce and deliver information (e.g., video to consumers) and receive information (e.g., user-feedback from those users about the video content). Broker 420 may be a bi-directional information broker. In this context, broker 420 may consume the output of video compiler 418, and once consumed, the compiled video output may be viewed by end-users, but only on behalf of broker 420, which is the interface for end-users to experience the final content result. As the key human interaction point with one or more individuals, broker 420 may serve as a recurring source of consumer context information, which may ultimately be aggregated and relayed to contextualizer 424, where this contextual information about the media compilation may be reprocessed to inform and enhance the fidelity of the individual or shared Memory.

In some embodiments, media consumption broker 420 may obtain context information not just from video, but also from a wide variety of media formats including, but not limited to: magazines, 3d spaces, games, images, generated video, interactive video, and podcasts.

In some embodiments, consumer moment contextualizer 424 may be configured to act as a dual-purpose player of memory interaction results with consumers/humans, which in turn may be used to enhance the range of possible guiding factors for moment anatomizer 414 and to act as a relay for a model reinforcer's (e.g., reinforcer 428) reinforcement learning and model retraining aggregation process. Some examples of contextual information that may be collected include comments, sentiment, fact presentation, and system extraction; soundtrack assignment; subject tagging; and related media associations.

In some embodiments, AI foundation model 408 may be configured to act as a back-end to Heart API 402, which may be an artificial neural network (ANN) modeler that may be used to instruct and carry out artificial intelligence (AI) functions. AI foundation model 408 may depend on, but may not be limited to, the use of down-sampling procedures to facilitate insights related to computer vision processes, also referred to as a convolutional neural network (CNN). AI foundation model 408 may be comprised of relevant sources of information that include, but are not limited to: media elements (photos, videos); photo subject identifiers and multi-subject relationships; storytelling detail and summarization; factual content based on object detection; predictive future experiences; layouts, captions, embellishments; shared consumer reactions and comments; memory enrichment; cycle times related to any per-instance process embodied by the system or supporting use cases; engagement quotients; fact verification confidence scores and thresholds; media action inferences as computed via any number of computer vision processes; and other empirical or deduced insights that may be relevant to generative adversarial networks (GAN), ANN, or CNN based processing algorithms.

In some embodiments, model reinforcer 428 may be configured to act as an AI reinforcement learning and model retraining aggregator and relay for the AI Foundation model. The reinforcements may be aggregated based on memory interaction between the video consumers at the point where a memory becomes available via the media consumption broker.

In some embodiments, block diagram 500 may make use of a collection of media and context related to the collection of media from a variety of users referred to as “memory”, that together specifically describe a human memory. Context and media may always be added to memory 502, resulting in memory 502 changing over time. Context and media may be validated by users.

In some embodiments, block diagram 500 may also make use of non-visual details about a memory referred to as “memory context”, like a photo positioned bigger on the page than others. Authors (e.g., A1 . . . A(n)) may create new memories and context added to the core collection of memories and subject context. Authors may have the most impact on the memory creation and augmentation cycle. Consumers (e.g., C1 . . . C(n)) may view and leave commentary (likes, comments) related to memories and video sequences, but may not add context. Contributors (e.g., D1 . . . D(n)) may view, leave commentary, and customize video sequences. Contributor changes may impact the memory context. For example, a grandmother may use broker 420 to leave a comment when seeing a grandchild take their first steps. This comment may then be processed by contextualizer 424 to provide additional context about the grandchild or the moment that may be used to augment the memory. This example may illustrate the core cycle of understanding->presenting ->receiving feedback, and ->making improvements.

In some embodiments, memories like memory 502 may be created by authors, such that memory 502 may contain other memories, which may effectively be moments within memory 502, but for specificity, may simply be considered as “memories within memories.” For example, a trip to Paris (e.g., Paris memory 508) may be a memory that contains many memories within it, such as visiting the Eiffel Tower at night. Sequenced depictions of a memory, like a video, may be generated using the media and context from that memory. Users may use broker 420 to personalize the depictions in obvious ways, for example, by filtering, sorting, excluding, or adding new media and context to further shape the depiction of how they remember events. This personalization, additional media, and context may be saved into a memory resulting in more specific and accurate depictions. This cycle of depict-personalize-augment-depict may repeat endlessly for one or many users who view the depiction. In this way, a memory may be continuously refined according to the user's perspective on how the memory occurred. The child's memories may be depicted and improved with the same process.

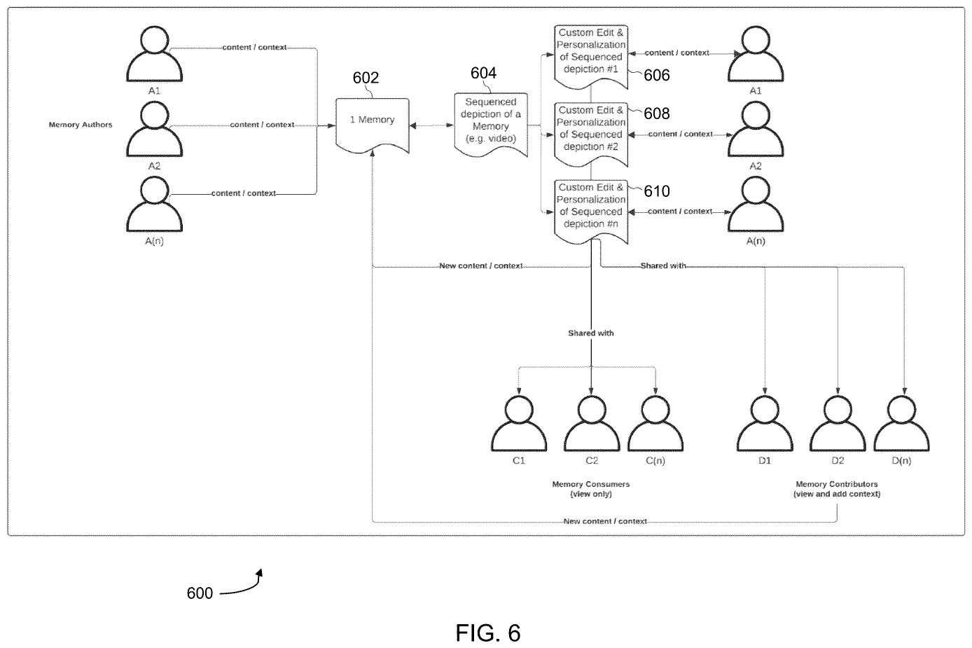

Referring now to FIG. 6 in view of FIGS. 4-5, a block diagram (e.g., block diagram 600) depicting how a “memory” construct is created and improved by users of different role types, according to embodiments of the present disclosure, is provided. According to block diagram 600, authors (e.g., A₁, A₂, . . . , Aₙ) may capture memories (e.g., memory 602) and memory context via media taken with their phone and actions taken on their phone to organize and contextualize said media in a container, like a photo book. Many authors may use broker 420 to add media and context to a single memory (e.g., Paris memory 508). Memory 602 may be considered a database of related media and context, both directed by authors (e.g., A₁, A₂, . . . , Aₙ) and inferred by the AI foundation model (e.g., AI foundation model 408). The memory generation system may automatically generate a sequenced depiction of the memory (e.g., sequenced depiction 604, provided by contextualizer 424) based on all available media and context. Essentially, this may be considered a video montage with music that matches the emotion of memory 602 with subtitles that may describe who is in the memory and what is happening in any given photo or video. Further, the memory generation system may provide priority order and timing to the presentation of the media, excluding duplicate or unimportant images and emphasizing the beginning, middle, end, and all moments in between the given memory.

In some embodiments, when authors see other previously created depictions, they may personalize the current depiction according to how they personally remember memory 602. They may edit any property of the depiction by changing the music, correcting the subtitles, adjusting the media order or importance, adding embellishments (e.g., Stickers or FX) to any moment in the sequence, and performing additional “edits” akin to customizing a photo book. These edits may be saved as a personalized depiction of the memory (e.g., personalized depictions 606, 608, 610), and they may also be analyzed for additional specifics about memory 602 that may be used to provide more context, further enhancing the specificity of memory 602 and any related depictions for all users. The flow of new content (media) and new context (specific details) that authors (e.g., A₁, A₂, . . . , Aₙ) may add while viewing the previously created depictions. Any depiction, personalized or not, may be shared with memory consumers (e.g., C₁, C₂, . . . , Cₙ) who have the ability to view but not change, personalize, or add to the memory. Any depiction, whether personalized or not, may be shared with memory contributors (e.g., D1, D2, . . . , Dn), who may add context but not personalize the memory. The contributor context may be fed back into memory 602 to involve the same elements, with the only difference being the nature of the messaging app used to send the message.

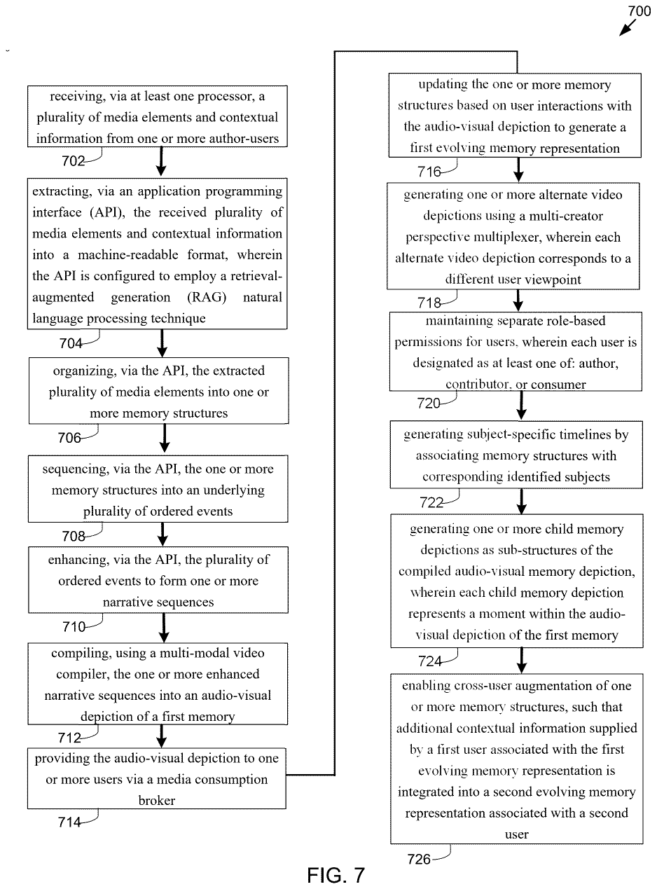

Referring now to FIG. 7 a flowchart 700 depicting the memory generation process 10 for generating a multi-perspective memory according to embodiments of the present disclosure is provided. Memory generation process 10 may include receiving (702), via at least one processor, a plurality of media elements and contextual information from one or more author-users, extracting (704), via an application programming interface (API), the received plurality of media elements and contextual information into a machine-readable format, wherein the API may be configured to employ a retrieval-augmented generation (RAG) natural language processing technique, and organizing (706), via the API, the extracted plurality of media elements into one or more memory structures configured to associate each media element with system-validated truths and subject identifiers. Memory generation process 10 may also include sequencing (708), via the API, the one or more memory structures into an underlying plurality of ordered events, enhancing (710), via the API, the plurality of ordered events to form one or more narrative sequences and applying symbolic, emotional, and dramatic layers to the one or more narrative sequences, and compiling (712), using a multi-modal video compiler, the one or more enhanced narrative sequences into an audio-visual depiction of a first memory. Memory generation process 10 may further include providing (714) the audio-visual depiction to one or more users via a media consumption broker and updating (716) the one or more memory structures based on user interactions with the audio-visual depiction to generate a first evolving memory representation.

In some embodiments, memory generation process 10 may include generating (718) one or more alternate video depictions using a multi-creator perspective multiplexer, wherein each alternate video depiction corresponds to a different user viewpoint, maintaining (720) separate role-based permissions for users, wherein each user is designated as at least one of: author, contributor, or consumer, and generating (722) subject-specific timelines by associating memory structures with corresponding identified subjects. Memory generation process 10 may further include generating (724) one or more child memory depictions as sub-structures of the compiled audio-visual memory depiction, where each child memory depiction represents a moment within the audio-visual depiction of the first memory.

In some embodiments, improving the “understanding” of a photo book may involve breaking the photo book down into objects that may be expanded, combined, and presented in different ways. The memory generation system may include a “shared memory,” shareable by 1 or 1 million, and “understandings” (aka memories) that may grow and expand over time based on the context loop. The method may further include enriching “understandings” by adding context, then re-analyzing them for greater accuracy, detail, and ultimately, reminiscing.

In some embodiments, the memory generation process may include multiplexing, enriching, and remixing “understandings” for multiple related persons who are either depicted within the memory content, through added context, or by way of sharing during the reminiscing process. The memories extracted from the same photo book by the same author may be interlinked, so that details from one book/understanding may influence the “understandings” of another.

In some embodiments, the memory generation process may include interpreting the timelines of multiple related individuals to combine multi-party perspectives on shared memories that intersect with one another, resulting in a more comprehensive 360-degree memory for associated contributors. Further, context profiles may be abstracted bits of user information that the user manages, enabling an artificial intelligence (AI) to make smarter decisions without “memorizing” the context. This approach may effectively abstract the personally identifiable information (PII) from the language learning model (LLM).

In some embodiments, an interactive video may be a type of media where users may change the music, editing style, and even the directorial approach. Further, the interactive video may be reassembled and represented instantly.

In some embodiments, the memory generation process may include a “sing-it-to-me” service, where a memory may be sung, narrated, or otherwise presented by an AI-generated song, lyrics, or script based on the AI foundation model's understanding of the memory.

It will be apparent to those skilled in the art that various modifications and variations may be made to memory generation process 10 and/or embodiments of the present disclosure without departing from the spirit or scope of the invention. Thus, it is intended that embodiments of the present disclosure cover the modifications and variations of this invention provided they come within the scope of the appended claims and their equivalents.

What is claimed is:

1. A computer-implemented method for generating a multi-perspective memory, the method including:
receiving, via at least one processor, a plurality of media elements and contextual information from one or more author-users;
extracting, via an application programming interface (API), the received plurality of media elements and contextual information into a machine-readable format, wherein the API is configured to employ a retrieval-augmented generation (RAG) natural language processing technique;
organizing, via the API, the extracted plurality of media elements into one or more memory structures;
sequencing, via the API, the one or more memory structures into an underlying plurality of ordered events; and
enhancing, via the API, the plurality of ordered events to form one or more narrative sequences.

2. The method of claim 1, further comprising
compiling, using a multi-modal video compiler, the one or more enhanced narrative sequences into an audio-visual depiction of a first memory;
providing the audio-visual depiction to one or more users via a media consumption broker; and
updating the one or more memory structures based on user interactions with the audio-visual depiction to generate a first evolving memory representation.

3. The method of claim 1, wherein the associations between each media element, the system-validated truths, and the subject identifiers are based on neural network routines within an artificial intelligence (AI) foundation model.

4. The method of claim 1, wherein organizing the extracted plurality of media elements includes generating a multidimensional array configured to relate each media element to one or more contextual descriptors and subject relationships.

5. The method of claim 1, wherein the received contextual information includes at least one of: captions, page placement, media emphasis, time metadata, subject identity, or user-supplied annotations.

6. The method of claim 1, further comprising:
generating one or more alternate video depictions using a multi-creator perspective multiplexer, wherein each alternate video depiction corresponds to a different user viewpoint.

7. The method of claim 1, wherein enhancing the ordered events includes at least one of: assigning soundtrack selections, narration, or visual styles based on inferred emotional context of the memory.

8. The method of claim 2, wherein updating the one or more memory structures includes non-destructively incorporating user edits, commentary, or personalization as additional context.

9. The method of claim 2, further comprising:
maintaining separate role-based permissions for users, wherein each user is designated as at least one of: an author, a contributor, or a consumer.

10. The method of claim 1, further comprising:
generating subject-specific timelines by associating memory structures with corresponding identified subjects.

11. The method of claim 1, wherein compiling the one or more enhanced narrative sequences includes applying saliency detection to emphasize relevant regions of the media elements.

12. The method of claim 1, wherein updating the memory structures further includes retraining a foundation model using reinforcement learning derived from user interactions.

13. The method of claim 2, further comprising:
generating one or more child memory depictions as sub-structures of the compiled audio-visual memory depiction, wherein each child memory depiction represents a moment within the audio-visual depiction of the first memory.

14. The method of claim 2, further comprising:
enabling cross-user augmentation of one or more memory structures, such that additional contextual information supplied by a first user associated with the first evolving memory representation is integrated into a second evolving memory representation associated with a second user, wherein both the first and second users are identified as participating in at least one common event from the underlying plurality of ordered events included in the first evolving memory representation.

15. A non-transitory computer-readable storage medium having stored thereon instructions, which, when executed by a processor, result in one or more operations, the operations comprising:
receiving, via at least one processor, a plurality of media elements and contextual information from one or more author-users;
extracting, via an application programming interface (API), the received plurality of media elements and contextual information into a machine-readable format, wherein the API is configured to employ a retrieval-augmented generation (RAG) natural language processing technique;
organizing, via the API, the extracted plurality of media elements into one or more memory structures;
sequencing, via the API, the one or more memory structures into an underlying plurality of ordered events; and
enhancing, via the API, the plurality of ordered events to form one or more narrative sequences.

16. The non-transitory computer-readable storage medium of claim 15, further comprising
compiling, using a multi-modal video compiler, the one or more enhanced narrative sequences into an audio-visual depiction of a first memory;
providing the audio-visual depiction to one or more users via a media consumption broker; and
updating the one or more memory structures based on user interactions with the audio-visual depiction to generate a first evolving memory representation.

17. The non-transitory computer-readable storage medium of claim 15, wherein the associations between each media element, the system-validated truths, and the subject identifiers are based on neural network routines within an artificial intelligence (AI) foundation model.

18. A system for generating a multi-perspective memory, the system comprising:
at least one processor configured to execute one or more operations, the operations comprising:
receiving, via at least one processor, a plurality of media elements and contextual information from one or more author-users;
extracting, via an application programming interface (API), the received plurality of media elements and contextual information into a machine-readable format, wherein the API is configured to employ a retrieval-augmented generation (RAG) natural language processing technique;
organizing, via the API, the extracted plurality of media elements into one or more memory structures;
sequencing, via the API, the one or more memory structures into an underlying plurality of ordered events; and
enhancing, via the API, the plurality of ordered events to form one or more narrative sequences.

19. The system of claim 18, further comprising
compiling, using a multi-modal video compiler, the one or more enhanced narrative sequences into an audio-visual depiction of a first memory;
providing the audio-visual depiction to one or more users via a media consumption broker; and
updating the one or more memory structures based on user interactions with the audio-visual depiction to generate a first evolving memory representation.

20. The system of claim 8, wherein organizing the extracted plurality of media elements includes generating a multidimensional array configured to relate each media element to one or more contextual descriptors and subject relationships.
